(19) United States
(12) Patent Application Publication
(10) Pub. No.: US 2009/0022876 A1
(43) Pub. Date: Jan. 22, 2009

(54) PROCESS FOR PREPARATION OF PLANT TISSUES OF PROCESSED BEANS, GRAINS, UNUTS/SEEDS, VEGETABLES OR FRUITS, PLANT TISSUES OF PROCESSED BEANS, GRAINS, NUTS/SEEDS, VEGETABLES OR FRUITS, AND PROCESSED FOOD PREPARED USING THE PLANT TISSUES

(76) Inventor: Takayuki Hara, Fukuoka (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/910,770

(22) PCT Filed: Mar. 16, 2006
(86) PCT No.: PCT/JP2006/305228

§ 371 Date: Nov. 20, 2007

(30) Foreign Application Priority Data
Apr. 7, 2005 (JP) 2005-111150

(51) Int. Cl. A23L 1/212; A23L 1/20

(52) U.S. Cl. 426/615

(57) ABSTRACT

The main purpose of this invention is to provide a simple and effective method of manufacturing plant tissues of “processed beans and so on” containing abundant cell tissues without using enzyme such as pectinase, which makes possible that dispersing cells of plant tissues of “beans and so on” as single cells without destruction of cell membrane, can maintain intracellular nutrients of plant tissues of “beans and so on” in the cell, and a smell characteristic to plant tissues of “beans and so on” is hardly present.

That is, this invention relates to a method of manufacturing plant tissues of processed beans and so on in which single cells of plant tissues of beans and so on are dispersed wherein a soaking step in which the plant tissues of beans and so on are soaked in water, a pressurization and a heating step in which the soaked plant tissues of beans and so on are pressured and heated in the presence of water, and a fine crushing step in which the pressured and heated plant tissues of beans and so on are crushed finely at a temperature of more than 30° C.

### BACKGROUND OF THE INVENTION

1. Field of the Invention

The present invention relates to a method of manufacturing plant tissues of processed beans, grains, nuts/seeds, vegetables or fruits, plant tissues of processed beans, grains, nuts/seeds, vegetables or fruits manufactured by the method, and processed food using the plant tissues. The plant tissues of beans, grains, nuts/seeds, vegetables or fruits refer to the plant tissues of beans (red bean, soybean, and black soybean), grains (buckwheat), nuts/seeds (black sesame, white sesame, and almond peel), vegetables (carrot and pak-choi), fruits (lemon peel, orange peel, apple peel, strawberry, and kiwi), respectively.

2. Description of the Related Art

Plant tissues of beans including soybean, grains, nuts/seeds, vegetables or fruits (referred to hereinafter as “beans and so on”) are nutritionally good food materials containing abundant vitamins, as well as well-balanced protein, sugar, and lipid, with small or large amount of the quantity. However, a digestion-absorption coefficient of plant food materials for human body is low even in case of cooking as boiled beans or parched beans, because such plant tissues of “beans and so on.” are hard. For the purpose of solving the problem, improvement of the digestion and absorption is done by processing the “beans and so on”, such as the crushing after the heating. For example, main processed foods of soybean, that are soybean milk, tofu, and so on, are mainly utilized as water soluble proteins and emulsified oils and fats of soybean, however, other part of soybean is disposed as okara. For this reason, abundant nutritional constituents contained in soybean are not used sufficiently. Hereinafter, the case of soybean is mainly explained.

In the past, efforts have been made to use a soybean powder obtained by mechanically pulverizing soybean or soybean cake. However, the soybean powder has a smell characteristic to soybean since soybean cells are destroyed during the pulverization operation. This characteristic limits the range of its application and amounts added as a food ingredients. While soybean proteins extracted from soybean cake are often used for processed foods, the smell of soybean is also strong in the case, and the application is thus limited.

As an improved technology to resolve the problems mentioned above, a method of processing soybean has been proposed using pectinase, an enzyme produced from bacteria, the genus Bacillus (see, for example, JP-B-3256534). According to the method, it has been shown that dispersion of soybean single cells can be achieved by a pectinase treatment without the destruction of cell membrane, and homogeneous powder of processed soybean with a high nutritional value devoid of the characteristic smell of soybean can be obtained. However, it is necessary to improve this method because the processing method with the pectinase treatment needs multiple steps such as the enzyme treatment and the treatment for inactivation of the enzyme, and it is time consuming for the job.

One hand, as a method of processing soybean without using an enzyme, a method of manufacturing the soybean food materials has been proposed, in which hulled and hypocotyl-removed soybean, that is not substantially swelled by water absorption, is under the determined conditions soaked, heated, and crushed in the hot water in which alkali has been added (see, for example, JP-A 10-99037). According to this method, the soybean food materials with good flavor and taste can be obtained because soybean cells are not destroyed, however, the problems remain to be resolved that pretreated steps are needed for hulling and removing of hypocotyls of soybean, processing steps are complicated after all, and some time-consuming is needed for the processing. Moreover, food fibers and isoflavones contained in soybean skin and the hypocotyls cannot be used.

On the other hand, another method of processing soybean without using an enzyme, in which the beans are hydrated so as to become its water content of 75-95 weight %, treated for decomposing grains and processed for paste has been proposed (see, for example, JP-A 2004-41). It takes a long time for a soaking step or a soaking step after the crushing according to this method, so as to become its water content of 75 weight % and more. However, if soybean is soaked in water for a long time, it is feared that intracellular enzyme of soybean is activated to consume protein or oil droplet, and sufficient single cells of soybean are not obtained to cause a bad taste of soybean. It is also feared that soybean cells may be destroyed in other step of sterilization.

### SUMMARY OF THE INVENTION

The problems above described are discussed about mainly soybean, these problems are the same as plant tissues of other beans, grains, nuts/seeds, vegetables or fruits. The main purpose of this invention is to provide a simple and effective method of manufacturing plant tissues of “processed beans and so on” containing abundant cell tissues without using enzyme such as pectinase, which makes possible that dispersing cells of plant tissues of “beans and so on” as single cells without destruction of cell membrane, can maintain intracellular nutrients of plant tissues of “beans and so on” in the cell, and a smell characteristic to plant tissues of “beans and so on” is hardly present.

Also, other purpose of this invention is to provide plant tissues of “processed beans and so on” and the processed food including the plant tissues of “processed beans and so on”.

As a result of a wholehearted examination carried out by the present inventors in order to solve the above-mentioned subjects, it was found out that the above-mentioned object might be attained by a method for manufacturing plant tissues of “processed beans and so on” shown below, and we succeeded in this invention here.

That is, this invention relates to

a method of manufacturing plant tissues of processed beans, grains, nuts/seeds, vegetables or fruits in which single cells of plant tissues of beans, grains, nuts/seeds, vegetables or fruits are dispersed wherein

a soaking step in which the plant tissues of beans, grains, nuts/seeds, vegetables or fruits are soaked in water,

a pressurization and a heating step in which the soaked plant tissues of beans, grains, nuts/seeds, vegetables or fruits are pressured and heated in the presence of water,

and a fine crushing step in which the pressured and heated plant tissues of beans, grains, nuts/seeds, vegetables or fruits are crushed finely at a temperature of more than 30° C.

According to this method, plant tissues of “processed beans and so on” can be manufactured, being dispersed as single cells of plant tissues of “beans and so on” without destruction of cell membrane, maintaining nutrients in the cell, and being devoid of a smell characteristic to plant tissues of “beans and so on”. That is, enzymes that have been reported to be necessary for processing “beans and so on”, such as cellulase which is hydrolase of cellulose, hemicellulase which is hydrolase of hemicellulose, and pectinase which is hydrolase of pectin are not absolutely required; then cellulose, hemicellulose, and pectin are the cell wall components in plant tissues of “beans and so on”. Since the method does not need the treatment of hulling and removing hypocotyls, plant tissues of “processed beans and so on” dispersed as single cells of plant tissues of “beans and so on” can be manufactured with a shorter time and a more simple way compared with a conventional method, and food fibers and isoflavones present in the skin and the hypocotyls can be used effectively. Also, the inventor discovered that if the fine crushing step is carried out at more than the determined temperature, cell dispersion of plant tissues of “processed beans and so on” can be increased to manufacture plant tissues of “beans and so on” containing a high concentration of single cells. Thus, plant tissues of “processed beans and so on” can be manufactured with a higher concentration of cells of the plant tissues compared with a method of fine crushing at a lower temperature.

According to the method mentioned above, it does not take a time for treatment of soaking and the following possibilities are thus unlikely: activation of enzymes present in plant tissues of “beans and so on”, consumption of protein and oil droplet stored in the cell of plant tissues of “beans and so on”, decrease of single cell numbers of plant tissues of “beans and so on”, and production of a bad flavor. Plant tissues of “processed beans and so on” can be manufactured shortly and efficiently compared with a conventional method, because a pressurizing and heating step shares with a sterilization step as well as easier dispersion of single cells of plant tissues of “beans and so on”. Moreover, no waste and drain produce because raw materials of plant tissues of “beans and so on” are used as a whole.

It is preferable that soaking of plant tissues of beans, grains, nuts/seeds, vegetables or fruits is done within 5 hours in the soaking step. Plant tissues of “beans and so on” containing a high concentration of dispersed single cells of plant tissues of “processed beans and so on” can be manufactured by a pressurizing and heating step after a short time of the soaking treatment. The productivity is also improved because the time of soaking shortens.

It is preferable that the pressurization and heating is done in the presence of at least more than 2.5 weight part of water relative to 1 weight part of plant tissues of dried beans, grains, nuts/seeds, vegetables or fruits in the pressurization and heating step. By pressurization and heating in the presence of the determined amount of water, plant tissues of “processed beans and so on” containing a higher concentration of single cells of plant tissues of “beans and so on” can be manufactured.

It is also preferable that the pressurization and heating is done under the conditions of temperature of 110-125° C. and pressure of 1.2-1.7 kg/cm² in the pressurization and heating step. Single cells of plant tissues of “beans and so on” can be easily dispersed without destruction of cell membrane by pressurizing and heating under the determined conditions. Decrease in cell numbers of plant tissues of “beans and so on” can be prevented by deactivating enzymes present in plant tissues of “beans and so on”. Under the treated conditions mentioned above, plant tissues of “beans and so on” by the treatment of soaking can be sterilized to shorten the time of the process and improve the productivity.

It is preferable that the pressurized and heated plant tissues of beans, grains, nuts/seeds, vegetables or fruits in the fine crushing step are crushed finely at a temperature of more than 80° C. Plant tissues of “processed beans and so on” containing higher amounts of single cells of plant tissues of “beans and so on” can be manufactured by crushing finely at a temperature of more than 80° C. Since single cells of plant tissues of “beans and so on” thus obtained may not have a cell wall or have a part of a cell wall even if it exists, they are easier to be digested and absorbed into body than that of usual single cells having an intact cell wall of plant tissues of “beans and so on”.

Plant tissues of processed beans, grains, nuts/seeds, vegetables or fruits in this invention are characterized by manufacturing by using either method above descrived. Since single cells of plant tissues of “processed beans and so on” manufactured by the method of this invention in which the cell membrane is not destroyed are dispersed with a high concentration in plant tissues of “beans and so on”, nutrients are maintained in the cell of plant tissues of “beans and so on” without any leak, and oxidation or loss of nutrients can be prevented during the manufacturing process, they are excellent for a long preservation. They can be also used widely as raw materials for plant tissues of “beans and so on” to various kinds of processed food, since plant tissues of “beans and so on” does not have a smell characteristic to plant tissues of “beans and so on”.

It is preferable that plant tissues of processed beans, grains, nuts/seeds, vegetables or fruits are having puree forms in this invention. Since a puree form of plant tissues of “processed beans and so on” manufactured by the method of this invention is excellent for a long preservation, and it does not have a smell characteristic to plant tissues of “beans and so on”, they can be also used widely as raw materials for plant tissues of “beans and so on” to various kinds of processed food.

A processed food in this invention is characterized by comprising the plant tissues of processed beans, grains, nuts/seeds, vegetables or fruits. Since processed food including plant tissues of “processed beans and so on” manufactured by the method in this invention contains cells of plant tissues of “beans and so on” abundantly, it is excellent in nutrition, and it also hardly has a smell characteristic to plant tissues of “beans and so on”.

According to the manufacturing method in this invention mentioned above, plant tissues of “processed beans and so on” in which single cells of plant tissues of “beans and so on” are dispersed with a high concentration can be manufactured from raw materials of plant tissues of “beans and so on” without destruction of the cell membrane. Since single cells of plant tissues of “beans and so on” thus obtained may not have a cell wall or have a part of a cell wall if it exists, it is digested and absorbed into body easier. Moreover, waste and drain hardly produce because raw materials of plant tissues of “beans and so on” are used as a whole. In addition, plant tissues of “processed beans and so on” manufactured by the method in this invention have a good digestion-absorption coefficient to human body, an excellent nutritional value and also hardly have a smell characteristic to plant tissues of “beans and so on”.

### BRIEF DESCRIPTION OF THE DRAWINGS

FIG. 1 is a picture of a light microscope of processed soybean (example 1) manufactured by the method of this invention (a magnification of ×100).

FIG. 2 is a picture of a light microscope of the precipitated fraction stained by CBB (example 1) (a magnification of ×300).

FIG. 3 is a picture of a light microscope of processed soybean (example 2) manufactured by the method of this invention (a magnification of ×100).

FIG. 4 is a picture of a light microscope of processed soybean (example 3) manufactured by the method of this invention (a magnification of ×100).

FIG. 5 is a graph representing the relationship between the time period of soaking of plant tissues of “processed beans and so on” and cell numbers of plant tissues of beans, grains, nuts/seeds, vegetables or fruits present in plant tissues of “beans and so on”.

FIG. 6 are pictures of a light microscope of processed soybean (example 6) manufactured by the method of this invention (a magnification of ×100).

FIG. 7 are pictures of a light microscopic sections processed soybean and soybean treated with a soaking stained by Hematoxylin-Eosin (a magnification of ×100). (A); a picture of a side section of processed soybean of this invention, (B); a picture of a side section of soybean treated with a soaking, (C); a picture of a length section of processed soybean of this invention,(D); a picture of a length section of soybean treated with a soaking.

FIG. 8 are pictures of a light microscope of the supernatant fraction and precipitated fraction after centrifuge of the soybean which is crushed finely at 87° C. after pressurizing and heating treatment and that which is soaked. (A) and (D); a magnification of ×400, (C) and (D); a magnification of ×100. (A); the supernatant fraction of soybean crushed finely at 87° C., (B); the supernatant fraction of soybean treated with a soaking, (C); the precipitated fraction of soybean crushed finely at 87° C., (D); the precipitated fraction of soybean treated with a soaking.

FIG. 9 is a graph representing the relationship between the temperature of crushing of soybean and cell numbers of soybean present in processed soybean. Y-axis of the figure shows cell numbers/g of dried soybean, and X-axis shows the temperature at the treatment of crushing.

FIG. 10 are pictures of a light microscopes of processed soybean crushed at various temperature (a magnification of ×100). The temperatures in the pictures are shown when they were crushed.

FIG. 11 are graphs determining particle size distribution of particles present in processed soybean crushed at 10° C. and 87° C. (A); a particle size distribution of soybean crushed at 10° C., (B); a particle size distribution of soybean crushed at 87° C. Y-axis shows the volume (%), and X-axis shows the diameter of the particle (μm).

FIG. 12 is a graph representing the relationship between the time period of soaking of plant tissues of beans, grains, nuts/seeds, vegetables or fruits and cell numbers of plant tissues of processed beans, grains, nuts/seeds, vegetables or fruits present in plant tissues of beans, grains, nuts/seeds, vegetables or fruits.

FIG. 13 is a picture of a microscope of red bean puree (a magnification of ×400).

FIG. 14 is a picture of a microscope of black soybean puree (a magnification of ×100).

FIG. 15 are pictures of a microscope of buckwheat puree. (A); a magnification of ×100, (B); a magnification of ×400.

FIG. 16 is a picture of a microscope of black sesame puree (a magnification of ×100).

FIG. 17 is a picture of a microscope of hulled white sesame puree (a magnification of ×100).

FIG. 18 are pictures of a microscope of almond peel cell. (A) and (B); a magnification of ×100.

FIG. 19 is a picture of a microscope of carrot puree. (A); a picture of a microscope of the cell (a magnification of ×100), (B); a picture of a light microscope of the precipitated fraction stained by CBB.

FIG. 20 is a picture of a microscope of pak-choi cells.

FIG. 21 is a picture of a microscope of lemon peel puree (a magnification of ×100).

FIG. 22 is a picture of a light microscope of the precipitated fraction of apple peel puree stained by CBB.

FIG. 23 is a picture of a microscope of orange peel cells.

FIG. 24 is a picture of a microscope of strawberry cells.

FIG. 25 is a picture of a microscope of kiwi cells.

### DETAILED DESCRIPTION OF THE INVENTION

Embodiments of the invention will be described in the following description.

This invention relates to a method of manufacturing plant tissues of “processed beans and so on” in which single cells of plant tissues of “beans and so on” are dispersed. In this invention, “a single cell of plant tissues of processed beans, grains, nuts/seeds, vegetables, or fruits” means respective a cell that composes tissues of plant tissues of “beans and so on”, thus it includes a single cell having either an intact cell wall or a partially intact cell wall, and it also includes a single cell that does not have a cell wall. In this invention, a single cell that has a cell wall partially or does not have a cell wall is preferable. The single cell that has a cell wall partially or does not have a cell wall is easier to be digested and absorbed into body, and thus preferable as compared with a single cell having an intact cell wall. In this invention, “plant tissues of processed beans, grains, nuts/seeds, vegetables, or fruits in which single cells of plant tissues of processed beans, grains, nuts/seeds, vegetables, or fruits are dispersed” means plant tissues of “processed beans and so on” containing single cells of plant tissues of “beans and so on” being dispersed after an intercellular substance and a cell wall of plant tissues of “beans and so on” are partially or fully decomposed.

In addition, a paste form of plant tissues of “processed beans and so on”, a puree form of plant tissues of “processed beans and so on”, and a powder form of plant tissues of “processed beans and so on” are included in plant tissues of “processed beans and so on” manufactured by the method of this invention. A paste form of plant tissues of “processed beans and so on” is a viscoelastic form of plant tissues of “processed beans and so on” which maintains the form itself, and a puree form of plant tissues of “processed beans and so on” is a form of plant tissues of “processed beans and so on” which cannot retain the form itself having a higher water content than that of a paste form of plant tissues of “processed beans and so on”.

A method of this invention comprises a step of soaking in which plant tissues of “beans and so on” are soaked in water. Usually, raw materials of plant tissues of “processed beans and so on” are washed with water, and then plant tissues of “beans and so on” are soaked in water. It is preferable that raw materials of plant tissues of “beans and so on” themselves are used without crushing of plant tissues of “beans and so on”. In this case, the amount of water (water for soaking treatment) is not especially limited, however, an enough amount of water is required to soak plant tissues of “beans and so on”.

It is preferable that a time period of soaking plant tissues of “beans and so on” is within 5 hours, more preferable within 3 hours, particularly preferable within 1 hour. In addition, the lower limit of the soaking is practically more than 30 minutes. If plant tissues of “beans and so on” are soaked for more than 5 hours, the cell numbers of plant tissues of “processed beans and so on” decrease, and plant tissues of “processed beans and so on” containing a high concentration of single cells of plant tissues of “beans and so on” cannot be obtained. It is considered that a rapid consumption of energy for germination occurs in the cell of plant tissues of beans or nuts/seeds since water soaking to plant tissues of “beans and so on” itself is a process of promotion of germination. It is not preferable that a long time soaking of plant tissues in the case of grains or vegetables since the possibility of activation of protease is considered. In addition, if plant tissues become an activated state by soaking in water, it is considered that cell numbers are decreased by rapid destruction of cells of fruits for consumption of oil droplet or protein stored in the interior of the cell. Although a preferable time period for soaking of plant tissues of “beans and so on” which has been used as a desirable choice previously is 12 hours, this may drastically decrease cell numbers of plant tissues of “beans and so on” used in plant tissues of “processed beans and so on”.

Thus, it is necessary for obtaining plant tissues of “processed beans and so on” containing much more cells of plant tissues of “beans and so on.” that enzymes present in plant tissues of “beans and so on” must be deactivated by pressurizing and heating and so on to stop the process of germination in a very early stage that the germination occurs.

A soaking step of plant tissues of “beans and so on” can be done at room temperature, however, it is preferable that the soaking step is performed at as lower temperature as possible in the view of possible inhibition of the process of germination of plant tissues of “beans and so on”, concretely, 10-25° C.

Moisture content ratio of plant tissues of “beans and so on” by a soaking treatment is not especially limited, however, it is preferably less than 55 weight % more preferably less than 50 weight %, in particular preferably less than 35 weight %, comparative to the weight of plant tissues of “beans and so on”. Since it is necessary for a long time period of soaking treatment to be its moisture content ratio of over 55 weight %, as a result, activation of enzyme(s) present in plant tissues of “beans and so on”, occurs and single cell numbers of plant tissues of “beans and so on” decrease.

A method of this invention comprises a step of pressurization and heating in which plant tissues of “beans and so on” the soaked are pressurized and heated in the presence of water. Pressurization and heating can be done by conventionally known method and apparatus, and are not limited, but can be done by an apparatus such as an autoclave or a pressure cooker.

It is preferable that the pressurization and heating can be done at temperature of 110-125° C., and pressure of 1.2-1.7 kg/cm². A time period of the pressurization and heating is not limited, however, usually 5-35 minutes, and preferably 7-20 minutes. Particular preferable conditions are temperature of 121° C., and pressure of 1.4 kg/cm² for 7 minutes. The decomposition of intercellular substances of plant tissues of “beans and so on” or softening of the cell wall occurs and single cells of plant tissues of “beans and so on” become an easy state to be dispersed of plant tissues of “beans and so on”. In addition, bacteria contacting to plant tissues of “beans and so on” can be sterilized as well as the decrease in cell numbers of plant tissues of “beans and so on” can be minimized.

The pressurization and heating are done in the presence of water. By pressurizing and heating in the presence of water, plant tissues of “processed beans and so on” containing much more single cells of plant tissues of “beans and so on” can be manufactured. At least more than 2.5 weight part of the water relative to one part of dried plant tissues of “beans and so on” is preferable, more preferable of 2.5-10 weight part, and much more preferable of 5-10 weight part. If the water is less than 2.5 weight part, the cell numbers of plant tissues of “beans and so on” present in plant tissues of “processed beans and so on” decrease. One of the reasons is that plant tissues of “beans and so on” become difficult to be crushed after being dried of plant tissues of “beans and so on”. If the water exceeds more than 10 weight part, it takes a long time for the treatment at the step of manufacturing.

In addition, it is preferable that the soaking water used for soaking treatment is reused as that for the pressurization and heating. The drain can be controlled as small as possible in the manufacturing of plant tissues of “processed beans and so on”, and a very small amount of components of plant tissues of “beans and so on” which leak from plant tissues of “beans and so on” at the soaking process can be recovered.

A method of this invention comprises a step of fine crushing in which the pressurized and heated plant tissues of “beans and so on” are crushed at a temperature of more than 30° C. Single cells of plant tissues of “beans and so on” are perfectly dispersed by this treatment and homogeneous plant tissues of “processed beans and so on” can be obtained. It is important that the fine crushing should be done at the determined temperature. That is, the temperature condition in the crushing is more than 30° C., more preferably more than 70° C., and particularly preferable more than 80° C. The upper limit of temperature in the crushing is not limited especially, but it is practically less than 100° C. If the temperature of crushing is less than 30° C., numbers of single cells of plant tissues of “beans and so on” decrease, because the cell wall once softened by the pressurization and heating becomes hard, and cells of plant tissues of “beans and so on” become difficult to be dispersed sufficiently. Fine crushing can be done by a conventionally known method and an apparatus, and is not limited, but can be done by such as a home mixer, a stone roll, or a high-speed mill and so on, but an apparatus that can be used for crushing at more than 60° C. is preferable, and, especially, a container made of metal is preferable. In addition, the extent of crushing shouldn't be so strong as to extremely destroy the cells of plant tissues of “beans and so on”, for example, when a high pressure homogenizer is used, they can be crushed finely less than at 200 kg/cm².

Plant tissues of “processed beans and so on” obtained by the method of this invention become a puree form or a paste form of plant tissues of “processed beans and so on” by choosing amounts of water added appropriately. It is possible that the puree form of plant tissues of “processed beans and so on” is made from the paste of plant tissues of “processed beans and so on” by adding an appropriate amount of water, or the paste of plant tissues of “processed beans and so on” is made from the puree form of plant tissues of “processed beans and so on” by the concentration appropriately. To obtain the paste form of plant tissues of “processed beans and so on”, pressurization and heating are done by adding 2-4 weight part of water relative to 1 weight part of dried plant tissues of “processed beans and so on”.

Moreover, if the plant tissues of “processed beans and so on” are dried by a suitable method, a powder form of plant tissues of “processed beans and so on” can be obtained. A drying method includes, for instance, a spray drying method, flash drying method, or a freeze-drying method, but the spray drying method is especially more suitable. A spray drying method is a method, using such as a spray drier, in which a solution, an emulsion, or suspension containing food is fined to a powder form of ten to hundreds micrometers of particles by a spray, and is dried by a hot wind for all at once. A flash drying method is a method, using such as a flash drier, in which a pasty or muddy substance, or a particle-like substance in wet condition formed a particle in dry condition is dispersed into a rapidly hot stream, and is provided abstract with the hot stream. This powder form of plant tissues of “processed beans and so on” is good for a long preservation, and is used widely as raw materials of plant tissues of “processed beans and so on” in various kinds of processed foods, since it hardly has a smell characteristic to plant tissues of “beans and so on”.

Plant tissues of “processed beans and so on” in this invention can be used widely as raw materials for food, and processed foods containing them in this invention include such as bread, kinds of sweets, kinds of noodle, processed foods of meat, hamburger, meat ball or the like, mayonnaise, dressing, jam, curry, ice cream, or the like. These processed foods contain abundant nutritious constituents and a smell characteristic to plant tissues of “beans and so on” is hardly present.

### BEST MODE FOR CARRYING OUT THE INVENTION

Examples to show the compositions and effects of this invention concretely are described below. The following examples include mainly a verification process for the soybean, but verifications for other plant tissues of “beans and so on” are also included. Concretely, the following samples were used for the verification: red bean and black soybean, as kinds of beans; buckwheat, as kinds of grains; white sesame, black sesame, and peel of almond, as kinds of nuts/seeds; carrot and pak-choi, as kinds of vegetables; peel of lemon, peel of apple, strawberry, and kiwi, as kinds of fruits. However, they are not to be construed to limit the scope of the present invention.

### Example 1

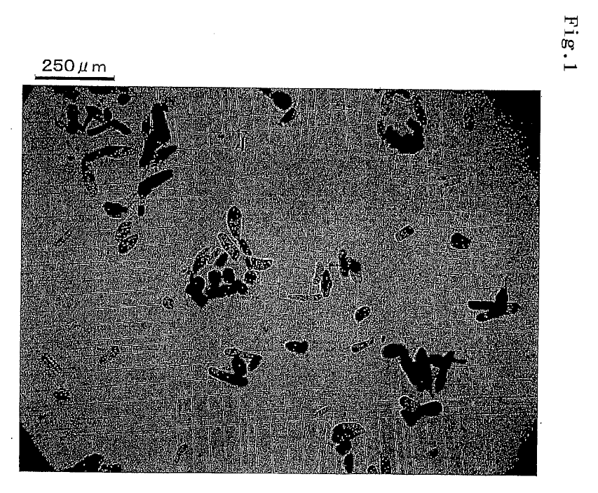

To 100 g of dried soybean (variety, Vinton), 500 ml of water was added, and kept (soaked) for 1 hour at room temperature (experimental numbers, 4). The mean values of wet weight of the soybean and water content percent after soaking were 155 g and 35.5 weight %, respectively. Next, to the soybean treated for soaking, the water for soaking treatment was adjusted to total water weight of 500 g (including the weight of water for soaking of the soybean), it was pressurized and heated at 121° C. and 1.4 kg/cm² for 7 minutes (treated at Fo value: 7 according to the Law of Food Hygiene of Japan) using an autoclave (SS-320 manufactured by TOMY SEIKO Co., Ltd.). The pressurized and heated soybean was crushed for 30 seconds at 11,000 rpm using a mixer (SM-229 manufactured by SANYO Co., Ltd.) with cooling, and processed soybean in this invention was obtained. The processed soybean obtained was hardly felt to have a smell characteristic to soybean. FIG. 1 shows a picture of a light microscope of the processed soybean. It shows that single cells of soybean are dispersed without destruction of the cell membrane. The cell numbers of the processed soybean were calculated by using a Thoma red blood cell counting chamber (manufactured by ERMA Co., Ltd.). Processed soybean obtained from this example contained more than 3×10⁷ of soybean cells/g of dried soybean, 3.58×10⁷ of soybean cells/g of dried soybean as the mean value. The obtained processed soybean was ultracentrifuged, and protein and DNA in the supernatant and the precipitated fractions were analyzed. Ultracentrifugation was done at 37,000 rpm for 60 minutes using an ultracentrifuge (XL-70 manufactured by Beckman Co. Ltd.). Protein determination was carried out by the methods of Lowry et al. and of Bradford, and DNA determination was carried out by the diphenylamine method. Analyses of the supernatant of the centrifuge show that 0.8% of total protein was detected in the supernatant. And, DNA was not detected at all. FIG. 2 shows a picture of a light microscope of the precipitated fraction. Only protein present in the interior of soybean cell was strongly stained by Coomassie brilliant blue, indicating that protein is not leaked to the outside of the cell.

### Example 2

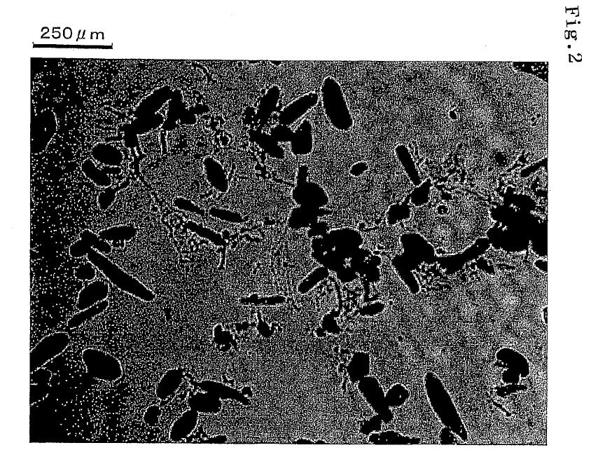

To 100 g of dried soybean (variety, Vinton), 500 ml of water was added, and kept (soaked) for 3 hours at room temperature (experimental numbers, 4). The mean values of wet weight of the soybean and water content percent after soaking were 202 g and 50.5 weight %, respectively. Next, the soaked soybean was pressurized and heated, and, treated of fine crushing as the same method of example 1, and the processed soybean was obtained. The processed soybean obtained was hardly felt to have a smell characteristic to soybean. FIG. 3 shows a picture of a light microscope of the processed soybean. It shows that single cells of soybean are dispersed without destruction of the cell membrane. Calculation of the cell numbers of the processed soybean by the same method as example 1 shows that it contained more than 2×10⁷ of soybean cells/g of dried soybean, 2.79×10⁷ of soybean cells/g of dried soybean as the mean value. The processed soybean obtained was ultracentrifuged, and protein and DNA in the supernatant and the precipitated fractions were analyzed. The ultracentrifuge and determinations of protein and DNA were carried out by the same method of example 1. Analyses of the supernatant of the ultracentrifuge show that 0.8% of total protein was detected in the supernatant. And, DNA was not detected at all.

### Example 3

To 100 g of dried soybean (variety: Vinton), 500 ml of water was added, and kept (soaked) for 5 hours at room temperature (experimental numbers, 4). The mean values of wet weight of the soybean and water content percent after soaking were 223 g and 55.5 weight %, respectively. Next, the soaked soybean was pressurized, heated, and, treated of fine crushing as the same method of example 1, and the processed soybean was obtained. The processed soybean obtained was hardly felt to have a smell characteristic to soybean. FIG. 4 shows a picture of a light microscope of the processed soybean. It shows that single cells of soybean are dispersed without destruction of the cell membrane. Calculation of cell numbers of the processed soybean shows that it contained more than 2×10⁷ of soybean cells/g of dried soybean, 2.115×10⁷ of soybean cells/g of dried soybean as the mean value calculated by the same method of example 1. The obtained processed soybean was ultracentrifuged, and protein and DNA in the supernatant and the precipitated fractions were analyzed. The ultracentrifuge and determinations of protein and DNA were carried out by the same method of example 1. Analyses of the supernatant of the ultracentrifuge show that 0.8% of total protein was detected in the supernatant. And, DNA was not detected at all.

### Reference Example 1

To 100 g of dried soybean (variety, Vinton), 500 ml of water was added, and kept (soaked) for 8 hours at room temperature (experimental numbers, 4). The mean values of wet weight of the soybean and water content percent after soaking were 226.2 g and 55.8 weight %, respectively. Next, the soaked soybean was pressurized, heated, and treated of fine crushing as the same method of example 1, and the processed soybean was obtained. The processed soybean obtained was hardly felt to have a smell characteristic to soybean. FIG. 4 shows a picture of a light microscope of the processed soybean. It shows that single cells of soybean are dispersed without destruction of the cell membrane. Calculation of cell numbers of the processed soybean by the same method as example 1 shows that it contained 1.68×10⁷ of soybean cells/g of dried soybean as the mean value.

### Example 4

To 100 g of dried soybean (variety, Vinton), 500 ml of water was added, and kept (soaked) for 1 hour at room temperature (experimental numbers, 3). Next, to the soybean treated for soaking, after water including the water for soaking treatment was adjusted to total water weight of 250 g (including the weight of water for soaking), it was pressurized and heated at 121° C. and 1.4 kg/cm². for 7 minutes using an autoclave (SS-320 manufactured by TOMY SEIKO Co., Ltd.). The pressurized and heated soybean was crushed for 30 seconds at 11,000 rpm using a mixer (SM-229 manufactured by SANYO Co., Ltd.) with cooling, and the processed soybean was obtained. Calculation of cell numbers of the processed soybean by the same method as example 1 shows that it contained more than 2×10⁷ of soybean cells/g of dried soybean, 2.1×10⁷ of soybean cells/g of dried soybean as the mean value.

### Example 5

To 100 g of dried soybean (variety: Vinton), 500 ml of water was added, and kept (soaked) for 1 hour at room temperature (experimental numbers, 3). Next, to the soybean treated for soaking, after water including the water for soaking treatment was adjusted to become a total water weight of 500 g (including the weight of water for soaking), it was pressurized, heated, and treated of fine crushing as the same method of example 4, and the processed soybean was obtained. Calculation of cell numbers of the processed soybean by the same method as example 1 shows that it contained more than 2×10⁷ of soybean cells/g of dried soybean, 2.1×10⁷ of soybean cells/g of dried soybean as the mean value.

### Reference Example 2

To 100 g of dried soybean (variety, Vinton), 500 ml of water was added, and kept (soaked) for 1 hour at room temperature (experimental numbers, 3), it was pressurized, heated, and treated of fine crushing by the same method as example 4 without adding any water except that water for the soaking treatment. Calculation of cell numbers of the processed soybean by the same method of example 1 shows that it contained 1.28×10⁷ of soybean cells/g of dried soybean as the mean value.

TABLE 1

| | Time of soaking | | | | | | | | |
|---|---|---|---|---|---|---|---|---|---|
| | 1 hour soaking (Example 1) | | | 3 hour soaking (Example 2) | | | 5 hour soaking (Example 5) | | |
| | Wet | Weight of | | Wet | Weight of | | Wet | Weight of | |
| | weights of | remained | Total | weights of | remained | Total | weights of | remained | Total |
| | soybean | water | weight | soybean | water | weight | soybean | water | weight |
| Experiment 1 | 153 | 440 | 593 | 196 | 400 | 596 | 219 | 380 | 599 |
| Experiment 2 | 156 | 435 | 591 | 206 | 391 | 597 | 222 | 365 | 587 |
| Experiment 3 | 155 | 437 | 592 | 202 | 394 | 596 | 225 | 370 | 595 |
| Experiment 4 | 157 | 438 | 595 | 205 | 390 | 595 | 225 | 370 | 595 |
| Mean Value ± SD | 155 ± 2 | 438 ± 2 | 593 ± 2 | 202 ± 5 | 394 ± 5 | 595 ± 1 | 223 ± 3 | 371 ± 6 | 594 ± 5 |

As shown in results of Table 1, a wet weight of soybean increased owing to the absorption of water into the soybean, as the time of soaking passes. Wet weights of soybean with soaking in 500 ml of water after 1 hour, 3 hours, and 5 hours became 1.55 fold, 2.02 fold, and 2.23 fold, respectively. Since the total weight which is the sum of the wet weight of soybean and the weight of remained water almost accorded with 600 g that is the sum of the dried weight of soybean and the weight of water, it is shown that this experiment was done accurately.

TABLE 2

| | 1 hour soaking | 3 hour soaking | 5 hour soaking |
|---|---|---|---|
| | (Example 1) | (Example 2) | (Example 3) |
| | (10⁴ cells/g | (10⁴ cells/g | (10⁴ cells/g |
| | of dried soybean) | of dried soybean) | of dried soybean) |
| Experiment 1 | 3400 | 2760 | 1920 |
| Experiment 2 | 3480 | 2940 | 2040 |
| Experiment 3 | 3480 | 2580 | 1920 |
| Experiment 4 | 3960 | 2880 | 2580 |
| Mean Value ± | 3580 ± 256 | 2790 ± 159 | 2115 ± 315 |
| SD | | | |

As shown in results of Table 2, cell numbers of soybean/g of dried soybean decreased as the time of soaking becomes long.

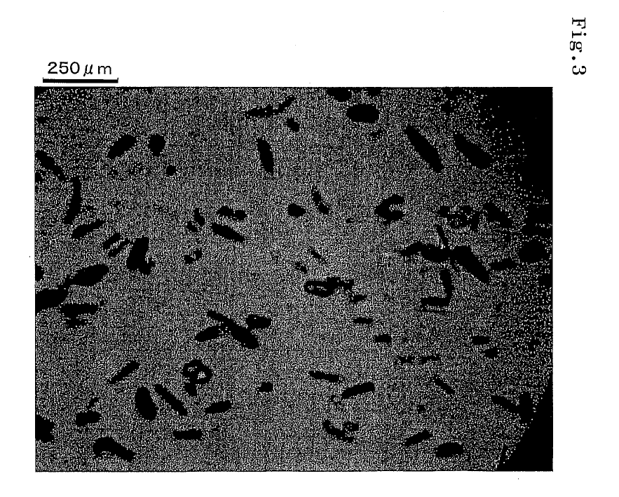

FIG. 5 shows the relationship between the time of soaking and cell numbers of soybean. It is shown that cell numbers of soybean/g of dried soybean decreased as the time of soaking becomes long. The time of soaking of 12 hours has been preferably used for the soaking, but it is supposed that cell numbers of soybean will decrease to be about 1×10⁷/g of dried soybean judging from FIG. 5.

TABLE 3

| | Without adding of | In the presence | In the presence |
|---|---|---|---|
| | water (Reference | of water 250 g | of water 500 g |
| | Example 2) | (Example 4) | (Example 5) |
| | (10⁴ cells/g | (10⁴ cells/g | (10⁴ cells/g |
| | of dried soybean) | of dried soybean) | of dried soybean) |
| Experiment 1 | 900 | 2100 | 3180 |
| Experiment 2 | 1380 | 1800 | 2940 |
| Experiment 3 | 1560 | 2400 | 2940 |
| Mean Value ± | 1280 ± 341 | 2100 ± 300 | 3020 ± 139 |
| SD | | | |

As shown in results of Table 3, the numbers of soybean cells remaining increased by the presence of water in the pressurization and heating treatment, and single cells of soybean contained mostly when dried soybean was treated with an autoclave in the presence of 500 ml of water.

The same results of the relationship between the time of soaking and the cell numbers in the case of soybean mentioned above were obtained in the case of other beans, grains, nuts/seeds, vegetables, or fruits. As the examples, the relationship between the time of soaking and cell numbers is shown in table 4 and FIG. 5 in red bean (beans), hulled white sesame (grains), carrot (vegetables), and peel of lemon (fruits). As shown in this observation, cell numbers of plant tissues of “beans and so on” per g of dried sample decreased as the time of soaking becomes long.

TABLE 4

| | |
|---|---|
| Plant tissues | Time of soaking |

| (10⁴ cells/g Sample) | 1 hour | 2 hour | 5 hour | 8 hour |
|---|---|---|---|---|
| Red bean | 1980 | 1860 | 1320 | 1080 |
| Hulled white sesame | 720 | 780 | 660 | 720 |
| Carrot | 60 | 54 | 60 | 66 |
| Peel of lemon | 1020 | 1080 | 780 | 480 |

### Example 6

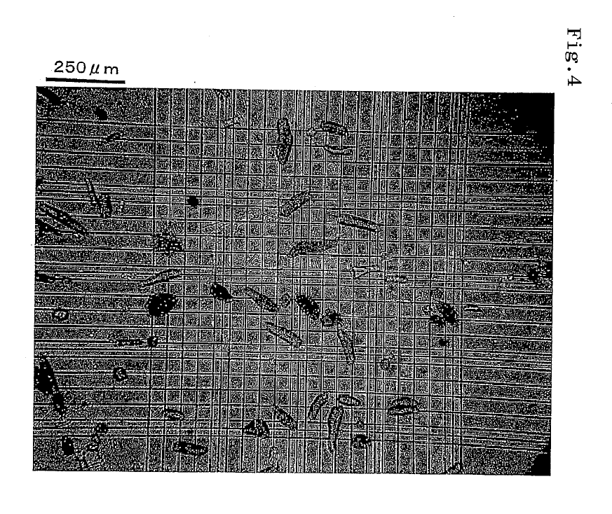

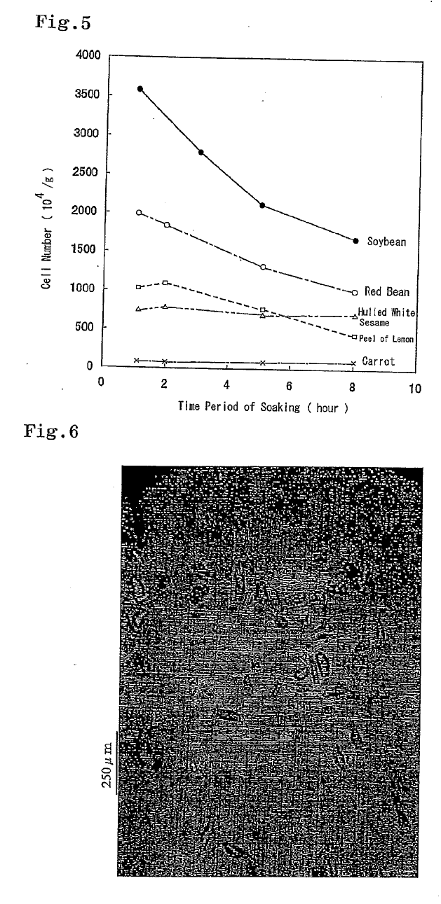

To 50 g of dried soybean (variety, Proto), 250 ml of water was added, and it was soaked for 1 hour at room temperature, and then treated for pressurization and heating using an autoclave (SS-320 manufactured by TOMY SEIKO Co., Ltd.) at 121° C., and 1.4 kg/cm² after adjusting to 300 g of total weight of water. The treated soybean was kept in a hot incubator (LCH-101 manufactured by ADVANTEC Co., Ltd.) to adjust to a temperature of 30° C. for crushing, then crushed finely using a homogenizer (AM-10 manufactured by ACE) at 16.000 rpm for 1 minute 3 times, and the processed soybean of this invention was obtained. FIG. 6 shows a picture of a light microscope of the processed soybean (a magnification of ×100). Since the length of a block is 50 μm, a single cell of 200 μm of soybean as a length can be seen. Since the cell is penetrated into a space of 0.1 mm of a red blood cell chamber in this observation, most of cells are seen as an elliptic shape. Furthermore, cell numbers of soybean contained were not different between Vinton and Proto for varieties of soybean.

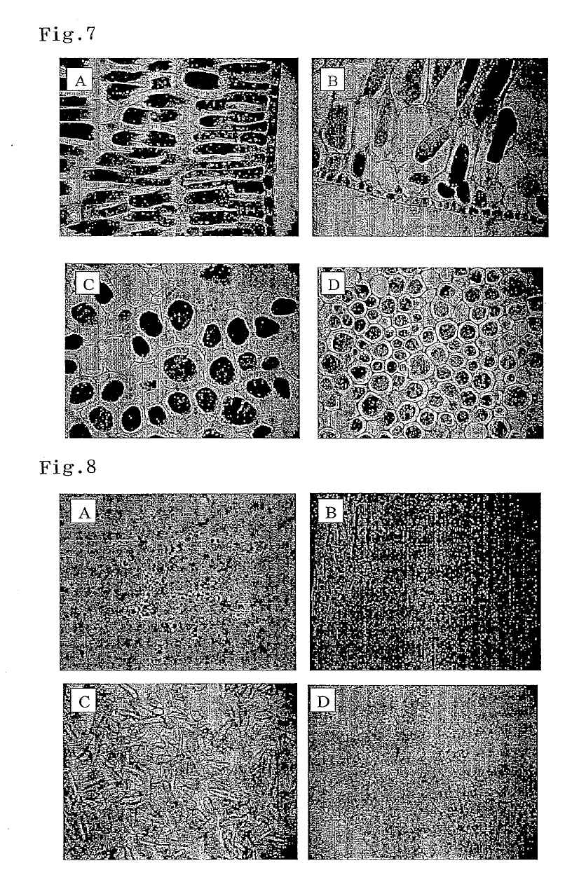

Pictures of plant tissues of “beans and so on” with a light microscope stained with Hematoxylin and Eosin are shown in FIGS. 7(A) and 7(C). FIGS. 7(A) and 7(C) show how to cut of a section. Pictures of plant tissues of “beans and so on” only treated with soaking with a light microscope stained with Hematoxylin and Eosin are also shown for the comparison [FIGS. 7(B) and 7(D)]. Since a portion stained with Hematoxylin and Eosin is protoplasm surrounded by cell membrane of a soybean cell, a thick portion seen with a white color is understood to be a cell wall. And it is understood that the shape of cell cross-cut is coincided with a picture shown in FIG. 6. From the results, it is suggested that the single cell of soybean shown in FIG. 6 consists of only cell membrane, losing its cell wall. In fact, when a puree form of processed soybean which contained about 1×10⁸ of the single cells was drunken, the feces of next day were examined carefully by a light microscope for the cell detection, but no single cells of soybean was detected. This indicates that the single cells of soybean observed in FIG. 6 have a cell wall partially even if it exists, indicating that it becomes a form to be digested in human digestive tract.

### Example 7

To 50 g of dried soybean (variety, Proto), 250 ml of water was added, and it was soaked for 1 hour at room temperature, and then treated for pressurization and heating using an autoclave (SS-320 manufactured by TOMY SEIKO Co., Ltd.) at 121° C., and 1.4 kg/cm² for 7 minutes after adjusting to 300 g of total weight of water. Next, it was crushed finely with a fine crusher apparatus. Since a fine crushing cannot be done at more than 60° C. by a usual glass mixer, a Warring blender made of stainless was used. The processed soybean was obtained by crushing using a Warring blender made of stainless (Ace homogenizer; AM-10 manufactured by Ace) at 16,000 rpm for 1 minute 3 times after adjusting a temperature to 87° C. using an incubator, LCH-101 manufactured by ADVANTEC Co., Ltd. To the processed soybean obtained an ethanol was added to precipitate the (single) cell of soybean, the processed soybean was then centrifuged at 5,000 rpm for 10 min using a centrifuge (6800 manufactured by Kubota Co. Ltd.), and the supernatant and the precipitated fractions were examined by a light microscope. A similar sample of soybean crushed finely after soaking in water was also examined for the comparison. The results are shown in FIG. 8. As shown in FIG. 8(A), cell wall constituents of soybean recovered in the supernatant of the processed soybean crushed finely at 87° C. were dispersed as a fine particle. On the other hand, cell wall constituents of soybean recovered in the supernatant fraction of soybean crushed finely with only soaking were dispersed as a rough particle [FIG. 8(B)]. Many dispersed single cells of soybean was observed in the precipitated fraction of soybean crushed finely at 87° C. [FIG. 8(C)], while no single cells from the precipitated fraction of soybean crushed finely with only soaking were observed [FIG. 8(D)]. Judging from the results, the reason of dispersion of soybean cells is understood that decomposition of intracellular substances and softening of cell wall components occur by pressurization and heating treatment, then dispersion of single cells of soybean to the suspension by fine crushing treatment occurs, and at the next step denaturation and hardening of proteins on the surface of the cells occur by the pressurization and heating treatment, which cannot be destroyed by the fine crushing treatment at the next step. A cell wall consists of fibers of cellulose, fibers of hemicellulose, pectin substances, and proteins that are embedded to make a net structure of a cell wall. This structural formation involves hydrogen bond among cellulose fiber molecules. To destroy the hydrogen bond, a heat from outside is effective. An autoclave treatment at 121° C. for 7 minutes destroys the hydrogen bond participated in the cell wall formation, thereby softens cell wall components, and single cells can be dispersed by a fine crushing treatment at 87° C.

Processed soybean crushed finely at various conditions of temperature was obtained by the same method as example 7 except that the fine crushing treatment was done at 10° C., 30° C., 70° C., or 80° C. Calculating single cell numbers of the processed soybean obtained by use of a Thoma red blood cell counting chamber (manufactured by Erma Co, Ltd.), showed that the single cell numbers are 3.06×10⁷/g of dried soybean at 10° C., 6.05×10⁷/g of dried soybean at 30° C., 7.05×10⁷/g of dried soybean at 70° C., 7.7×10⁷/g of dried soybean at 80° C., and 7.8×10⁷/g of dried soybean at 87° C., respectively.

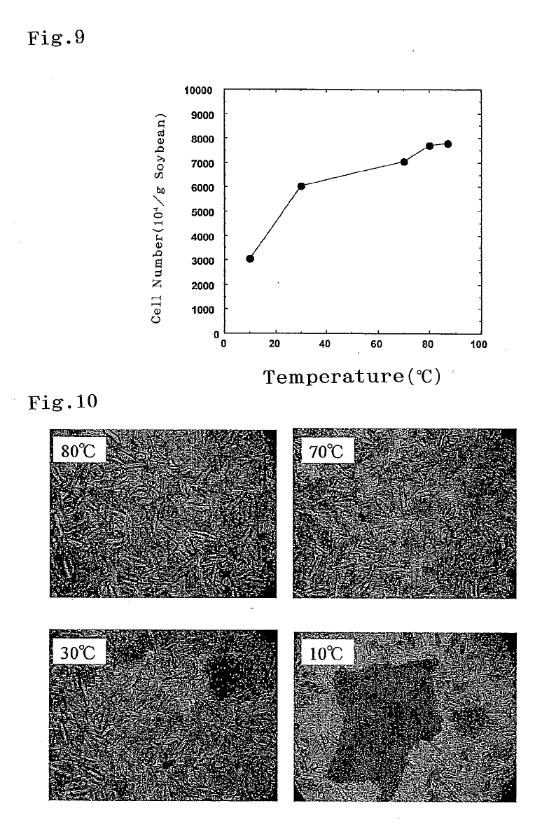

FIG. 9 shows the relationship between the temperature of fine crushing treatment and single cell numbers present in the processed soybean. As shown clearly in FIG. 9, the single cell numbers of soybean remarkably increased at 30° C., and the cell numbers extracted from soybean increased as the temperature of fine crushing increases.

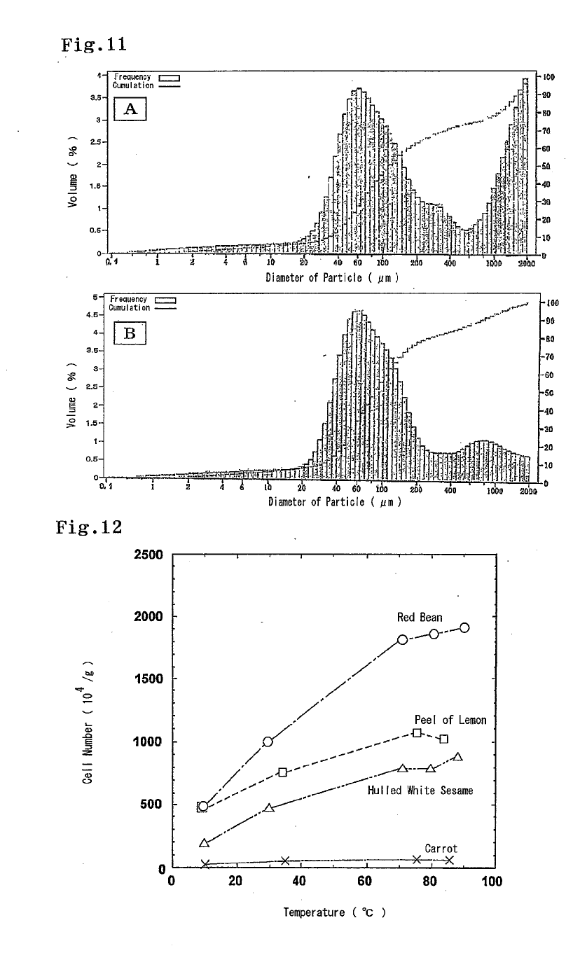

Pictures of a light microscope of processed soybean crushed finely at various temperatures are shown in FIG. 10. As clearly shown in the microscopic pictures, cell numbers of the soybean at 30° C. are observed to remarkably increase compared with those at 10° C., and the numbers increased as the temperature increases. In addition, the particles were observed to become finer. Practically processed beans as the puree form crushed at 87° C. were smooth of a good to the tongue. A distribution pattern of particle size of fine particles contained in processed soybean crushed finely at 87° C. or at 10° C. is shown in FIG. 11. A mean value of particle size of processed soybean crushed finely at 87° C. was 231.6 μm [FIG. 11(B)], while that at 10° C. was 442.9 μm, twice of that at 87° C. The most frequent particle size at 87° C. was 60.52 μm, while that at 10.° C. was 1909 μm. Determination of the distribution pattern of particle size was carried out for 1 minute after adjusting processed soybean to a concentration of 10% using a Frannhofer optical model LS-200 small module.

As mentioned above, it is shown that treatment with a mixer or a homogenizer in the hot condition after an autoclave treatment at 121° C. for 7 minutes is effective as a method to soften the cell wall. The manipulation mentioned above is not only advantageous for rapid processing of soybean puree, but also very suitable for administration of the sterilization treatment.

### Example 8

100 g of the materials, which are beans (red bean and black soybean), grains (buckwheat), nuts/seeds (white sesame, black sesame, and peel of almond), vegetables (carrot and pak-choi), fruits (peel of lemon, truth of apple, strawberry, and kiwi), was added of 500 ml of water, soaked in water at 22-24° C. for 1 hour, and then pressurized and heated using an autoclave (SS-320 manufactured by TOMY SEIKO Co., Ltd.) at 121° C. and 1.2-1.7 kg/cm² for 7 minutes after adjusting to 600 g of total weight of water, at the next step crushed finely at 80-90° C. (at the hot state) at 16,000-20,000 rpm for 1 min 3 times using a stainless Warring blender (Ace homogenizer; AM-10 manufactured by Ace), and then plant tissues of “processed beans and so on” were obtained. After addition of ethanol to plant tissues of “processed beans and so on” obtained, precipitation of the (single) cells, and centrifugation at 5000 rpm for 10 minutes using a centrifuge (6800 manufactured by Kubota Co. Ltd.), precipitated and supernatant fractions were observed with a light microscope.

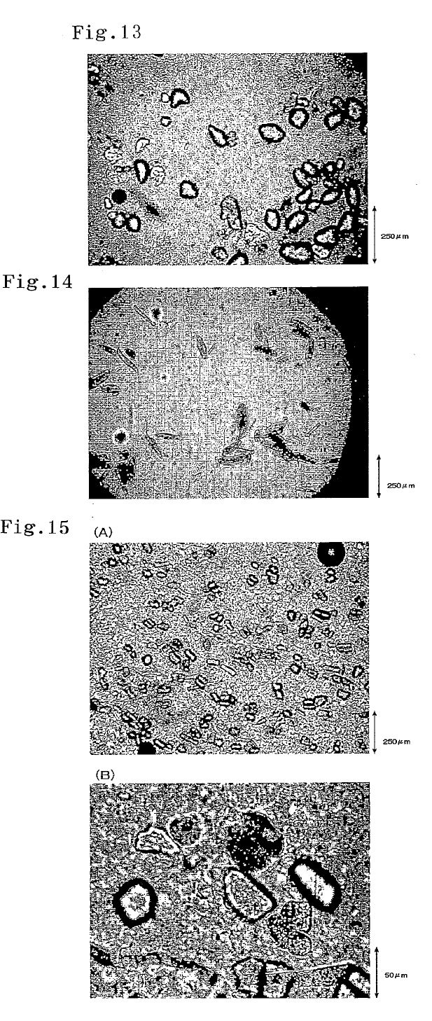

FIG. 12 shows the relationship between the temperature of fine crushing treatment and single cell numbers present in the plant tissues of “processed beans and so on”. As concrete examples, red bean, hulled white sesame, carrot, and peel of lemon are shown. As clearly shown in FIG. 12, the single cell numbers of red bean and hulled white sesame remarkably increased at 30° C., and the single cell numbers of red bean and hulled white sesame increased as the temperature of fine crushing increases. Thus, it was found that cell numbers of plant tissues of processed beans, grains, nuts/seeds, vegetables or fruits increase at more than 30° C. FIGS. 13-25 show the pictures of plant tissues of “processed beans and so on” crushed finely against the respective materials with a light microscope. As shown clearly in the pictures of a microscope, the cell numbers at 30° C. increased remarkably compared with those at 10° C., and the numbers increased as the temperature increases. In addition, the particles were observed to become finer. In fact, plant tissues of “processed beans and so on” as the puree form crushed at 87° C. were smooth of a good to the tongue.

FIG. 13 shows a picture of a microscope of red bean puree (a magnification of ×400). Cells are seen as slightly smaller than soybean with an elliptic shape of 100 μm as the major axis. The puree of red bean was smooth like a bean jam and not different from the taste of materials for red bean jam. The cell numbers were calculated to be 2.7×10⁷/g of dried red bean.

FIG. 14 shows a picture of a microscope of black soybean puree (a magnification of ×100). The major axis of the cells was about 200 μm, almost the same as that of soybean cell. The cell numbers were counted 3-4×10⁷/g of dried black soybean. A particular sweet taste was also felt in the case of black soybean. A sensory test where the sweet taste is derived was done after cells were centrifuged, and it is understood that the taste is derived from except for the cells. This indicates that this puree is useful for food materials.

FIG. 15 shows a picture of a microscope of buckwheat puree. FIG. 15(A) shows the picture of a magnification of ×100. The major axis of the cell was found as several 10 μms of a rod shape or an elliptic shape. The puree of buckwheat is viscid like milky lotion when it is hot, but becomes solid like buckwheat cake when it becomes cold. FIG. 15(B) is a magnified picture of 400 times.

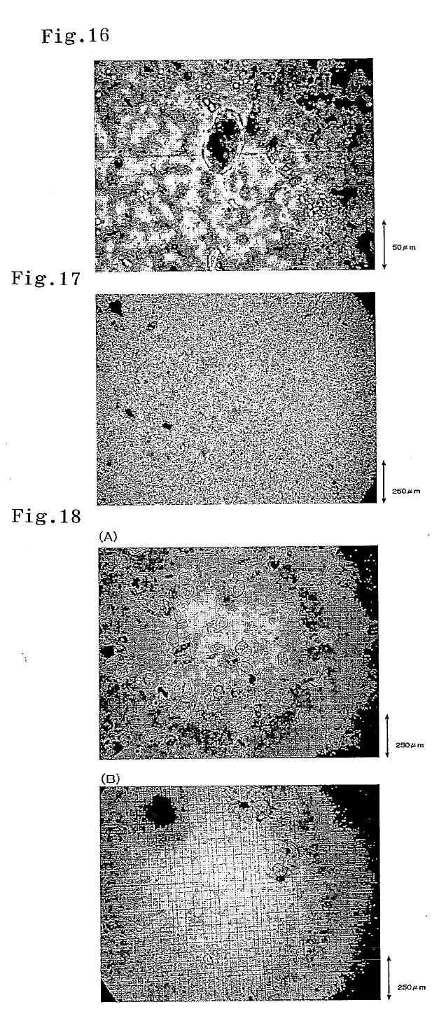

FIG. 16 shows a picture of a microscope of black sesame puree (a magnification of ×400). Many oil droplets are observed in puree of sesame. Cells are relatively small with the major axis of several 10 μms.

FIG. 17 shows a picture of a microscope of hulled white sesame puree (a magnification of ×400). Many oil droplets are observed. The cell numbers were calculated to be 7.3×10⁶/g of dried hulled white sesame. Those of black sesame and parched sesame were almost the same.

FIG. 18(A) shows a picture of a microscope of the cell puree of peel of almond (a magnification of ×100). Because a peel of almond is hard, it is necessary to use an apparatus having a stronger power of rotation to crush perfectly. For example, using a Polytron type homogenizer was more effective. FIG. 18(B) shows a picture for the determination of the cell numbers of the cell puree of peel of almond (a magnification of ×100), counted as 3.52×10⁶/g of dried peel of almond.

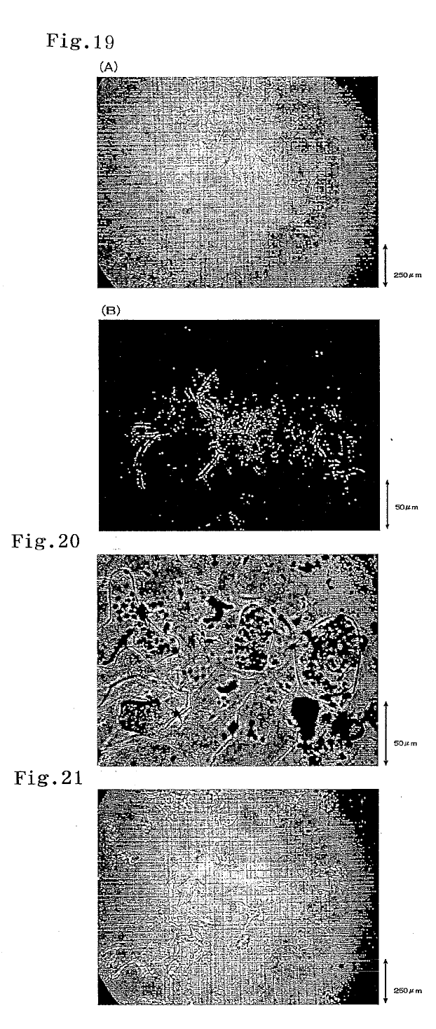

FIG. 19(A) shows a picture of a microscope of carrot puree (a magnification of ×100). FIG. 19(B) also shows a picture of a light microscope of the precipitated fraction of carrot peel puree stained by CBB. It is a very large cell of several 100 μms.

FIG. 20 shows a picture of a microscope of pak-choi cells. Precipitated fraction stained by CBB is shown.

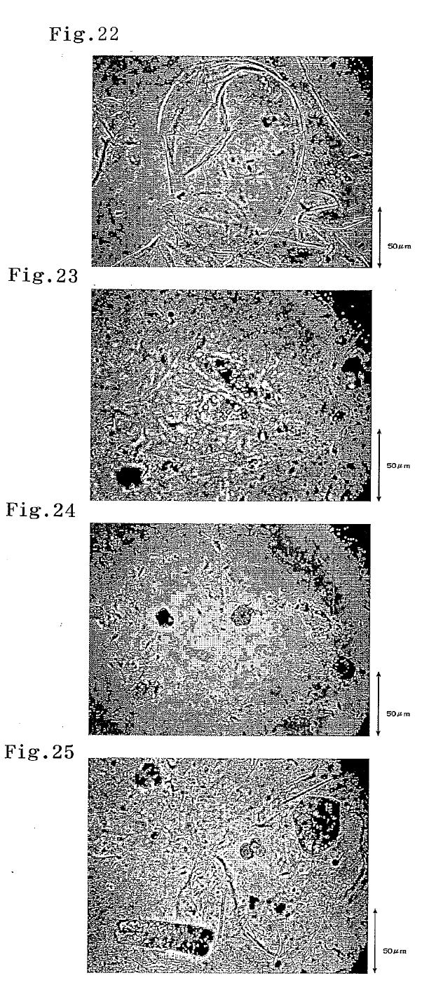

Several pictures of a light microscope are shown as examples of fruits. FIG. 21 shows a picture of a microscope of lemon peel puree (a magnification of ×100). FIG. 22 shows a picture of a light microscope of the precipitated fraction of apple peel puree stained by CBB. FIG. 23 also shows a picture of a microscope of orange peel cells. FIG. 24 shows a picture of a microscope of strawberry cells. Precipitated fraction stained by CBB is shown. FIG. 25 shows a picture of a microscope of kiwi cells. Precipitated fraction stained by CBB is shown.

All purees were found to be stable for at least 1 month at the room temperature without putrefaction. The taste was similar to that of juice respectively. As described above, it is suggested that the components of the taste is not derived from inner cellular substances but from components from cell wall.

As the method for using these purees, they are possible for juice to drink, and also possible for kneading to bread. Moreover, kneading to noodle of wheat as a powder after making a powder by a spray drier is possible. In addition, they are possible to use not only for food but also for cosmetics.

1. A method of manufacturing plant tissues of processed beans, grains, nuts/seeds, vegetables or fruits in which single cells of plant tissues of beans, grains, nuts/seeds, vegetables or fruits are dispersed, comprising:
a soaking step comprising soaking plant tissues of beans, grains, nuts/seeds, vegetables or fruits in water,
a pressurization and heating step comprising pressurizing and heating the soaked plant tissues of beans, grains, nuts/seeds, vegetables or fruits in the presence of water, and
a fine crushing step comprising crushing finely the pressured and heated plant tissues of beans, grains, nuts/seeds, vegetables or fruits at a temperature of more than 30° C.

2. A method of manufacturing plant tissues of processed beans, grains, nuts/seeds, vegetables or fruits according to claim 1, wherein
the soaking of the plant tissues of beans, grains, nuts/seeds, vegetables or fruits is conducted for 5 hours or less in the soaking step.

3. A method of manufacturing plant tissues of processed beans, grains, nuts/seeds, vegetables or fruits according to claim 1, wherein
the pressurization and heating is conducted in the presence of at least more than 2.5 weight part of water relative to 1 weight part of the plant tissues of dried beans, grains, nuts/seeds, vegetables or fruits in the pressurization and heating step.

4. A method of manufacturing plant tissues of processed beans, grains, nuts/seeds, vegetables or fruits according to claim 1, wherein
the pressurization and heating is conducted under conditions of temperature of 110-125° C. and pressure of 1.2-1.7 kg/cm² in the pressurization and heating step.

5. A method of manufacturing plant tissues of processed beans, grains, nuts/seeds, vegetables or fruits according to claim 1, wherein
the pressurized and heated plant tissues of beans, grains, nuts/seeds, vegetables or fruits in the fine crushing step are crushed finely at a temperature of more than 80° C.

6. Plant tissues of processed beans, grains, nuts/seeds, vegetables or fruits comprising single cells of plant tissues of beans, grains, nuts/seeds, vegetables or fruits which are dispersed therein, said plant tissues being manufactured by a method comprising:
a soaking step comprising soaking in which the plant tissues of beans, grains, nuts/seeds, vegetables or fruits are soaked in water,
a pressurization and a heating step comprising pressurizing and heating in which the soaked plant tissues of beans, grains, nuts/seeds, vegetables or fruits are pressured and heated in the presence of water, and
a fine crushing step comprising crushing finely in which the pressurized and heated plant tissues of beans, grains, nuts/seeds, vegetables or fruits are crushed finely at a temperature of more than 30° C.

7. Plant tissues of processed beans, grains, nuts/seeds, vegetables or fruits according to claim 6, having puree forms.

8. A processed food comprising a plant tissues of processed beans, grains, nuts/seeds, vegetables or fruits comprising single cells of plant tissues of beans, grains, nuts/seeds, vegetables or fruits which are dispersed therein, said plant tissues being manufactured by a method comprising:
a soaking step comprising soaking in which the plant tissues of beans, grains, nuts/seeds, vegetables or fruits are soaked in water,
a pressurization and a heating step comprising pressurizing and heating in which the soaked plant tissues of beans, grains, nuts/seeds, vegetables or fruits are pressured and heated in the presence of water, and
a fine crushing step comprising crushing finely in which the pressured and heated plant tissues of beans, grains, nuts/seeds, vegetables or fruits are crushed finely at a temperature of more than 30° C.

9. The method of manufacturing plant tissues of processed beans, grains, nuts/seeds, vegetables or fruits according to claim 1, wherein the soaking step, the pressurization and heating step, and the fine crushing step are conducted without using plant tissue digestive enzymes.

10. The method of manufacturing plant tissues of processed beans, grains, nuts/seeds, vegetables or fruits according to claim 1, wherein the soaking step is conducted at a temperature in a range of 10-25° C.

11. The method of manufacturing plant tissues of processed beans, grains, nuts/seeds, vegetables or fruits according to claim 1, wherein the soaking step is conducted to adjust a moisture content of the plant tissues to less than 55 weight % as measured after the soaking step.

12. The method of manufacturing plant tissues of processed beans, grains, nuts/seeds, vegetables or fruits according to claim 1, wherein the pressurization and heating step is conducted for 5-35 minutes.

13. The method of manufacturing plant tissues of processed beans, grains, nuts/seeds, vegetables or fruits according to claim 1, wherein said plant tissues is in powder form, and said method further comprising a drying step in which the finely crushed plant tissues are dried.
